(19) United States
(12) Patent Application Publication
(10) Pub. No.: US 2025/0374150 A1
(43) Pub. Date: Dec. 4, 2025

(54) User Equipment Handover Effect Prediction

(71) Applicant: Dell Products L.P., Round Rock, TX (US)

(72) Inventors: Abdulrahman Darwish, Cairo (EG); Medhat Khalifa, 6th of October, Giza (EG); Mina Khalaf Saad Girgis Moussa, Cairo (EG); Marwan Mansour, Alexandria (EG); Mohamed Abouzeid, El Sheikh Zayed (EG)

(21) Appl. No.: 18/678,986

(22) Filed: May 30, 2024

(51) Int. Cl. H04W 36/30; H04L 41/5009; H04W 24/02

(52) U.S. Cl. CPC H04W 36/304; H04L 41/5009; H04W 24/02

(57) ABSTRACT

A system can, for respective neighbor cells of neighbor cells of a cell that communicates with user equipment, use a trained machine learning model to predict respective first quality of experience values that the user equipment is predicted to receive while communicating with the respective neighbor cells, and respective second quality of experience values for respective existing user equipment in the respective neighbor cells in a case where the user equipment has communicated with the respective neighbor cells. The system can determine respective scores for the respective neighbor cells based on the respective first quality of experience values and the respective second quality of experience values. The system can perform a handover of the user equipment from the cell to a selected neighbor cell of the neighbor cells based on the selected neighbor cell being determined to have at least a threshold high score among the respective scores.

### BACKGROUND

A broadband cellular network can facilitate data transfer with user equipment (UE).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can facilitate broadband cellular communications with a user equipment, wherein the user equipment communicates with a cell, and wherein the cell has neighbor cells. The system can, for respective neighbor cells of the neighbor cells, using a trained machine learning model to predict respective first quality of experience values that the user equipment is predicted to receive while communicating with the respective neighbor cells, and respective second quality of experience values for respective existing user equipment in the respective neighbor cells in a case where the user equipment has communicated with the respective neighbor cells. The system can determine respective scores for the respective neighbor cells based on the respective first quality of experience values and the respective second quality of experience values. The system can perform a handover of the user equipment from the cell to a selected neighbor cell of the neighbor cells based on the selected neighbor cell being determined to have at least a threshold high score among the respective scores.

An example method can comprise, for respective neighbor cells of a cell of a cellular network that facilitates communications with a user equipment, using, by a system comprising at least one processor, a trained machine learning model to predict respective first quality of experience values that the user equipment would receive while communicating with the respective neighbor cells, and respective second quality of experience values for respective existing user equipment in the respective neighbor cells where the user equipment has been determined to have communicated with the respective neighbor cells. The method can further comprise determining, by the system, respective scores for the respective neighbor cells based on the respective first quality of experience values and the respective second quality of experience values. The method can further comprise facilitating, by the system, performance of a handover of the user equipment from the cell to a selected neighbor cell of the neighbor cells based on the selected neighbor cell having a highest score among the respective scores.

An example non-transitory computer-readable medium can comprise instructions that, in response to execution, cause a system comprising a processor to perform operations. These operations can comprise, for respective neighbor cells of a cell of a cellular network that facilitates communications with a device, projecting, with a trained machine learning model, respective first quality of experience values that the device is projected to receive while communicating with the respective neighbor cells, and respective second quality of experience values for respective existing devices in the respective neighbor cells where the device communicated with the respective neighbor cells. These operations can further comprise determining respective scores for the respective neighbor cells based on the respective first quality of experience values and the respective second quality of experience values. These operations can further comprise transferring the device from being connected to the cell to being connected to a selected neighbor cell of the neighbor cells based on the selected neighbor cell satisfying a score criterion.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate UE handover effect prediction, in accordance with an embodiment of this disclosure;

FIG. 2 illustrates another example system architecture that can facilitate UE handover effect prediction, in accordance with an embodiment of this disclosure;

FIG. 3 illustrates another example system architecture that can facilitate UE handover effect prediction, in accordance with an embodiment of this disclosure;

FIG. 4 illustrates an example signal flow that can facilitate UE handover effect prediction, in accordance with an embodiment of this disclosure;

FIG. 5 illustrates another example system architecture that can facilitate UE handover effect prediction, in accordance with an embodiment of this disclosure;

FIG. 6 illustrates another example system architecture that can facilitate UE handover effect prediction, in accordance with an embodiment of this disclosure;

FIG. 7 illustrates an example process flow that can facilitate UE handover effect prediction, in accordance with an embodiment of this disclosure;

FIG. 8 illustrates another example process flow that can facilitate UE handover effect prediction, in accordance with an embodiment of this disclosure;

FIG. 9 illustrates another example process flow that can facilitate UE handover effect prediction, in accordance with an embodiment of this disclosure;

FIG. 10 illustrates another example process flow that can facilitate UE handover effect prediction, in accordance with an embodiment of this disclosure;

FIG. 11 illustrates another example process flow that can facilitate UE handover effect prediction, in accordance with an embodiment of this disclosure;

FIG. 12 illustrates an example block diagram of a computer operable to execute an embodiment of this disclosure.

### DETAILED DESCRIPTION

### Overview

The present examples generally relate to Fifth Generation New Radio (5G NR) cellular communications technologies. It can be appreciated that they can be applied to other types of communications technologies, such as Long-Term Evolution (LTE) or Sixth Generation (6G).

In cellular networks, handovers (where the cell that services a user equipment (UE) switches) can be performed based on multiple events. For example, handovers can be performed in use-cases like load balancing and anomaly-based traffic steering.

Unguided handovers in these examples can degrade a user experience, since the handovers can usually be based on fixed thresholds on reference signal received power (RSRP) and other key performance indicators (KPIs), or based on forecasting methods that model a general KPI that is incapable of providing handover guidance by itself.

There can be a need for an improvement that predicts a value and consequences of a handover before executing that handover.

The present techniques can be implemented to facilitate a machine learning (ML) model that predicts a quality of experience that a user will have if the user is admitted to any of the neighbor cells. In addition, the model can predict an effect on existing users to facilitate jointly optimizing a general state of an offloaded UE from the source cell and the existing UEs on the target cell.

The present techniques can facilitate filtering neighboring cells based on radio frequency (RF) measurement thresholds. The present techniques can facilitate ranking candidate cells based on a post-processing step that gives a score for each cell indicating a value of the handover.

A ML model according to the present techniques can predict a value of a handover for both a moving UE and a target cell, which can facilitate avoiding negative consequences to both the moving UE and the target cell, and increase handover effectiveness.

A cell scoring formula can be implemented to evaluate a handover on each cell. The present techniques can be generalized, and compatible with different network slices (and configured by an operator). The present techniques can facilitate prioritizing between cell KPIs and UE KPIs (which can be configured by an operator).

In some examples, the present techniques can be implemented with an open radio access network (O-RAN) RAN intelligent controller (RIC), a service management and orchestration (SMO) component, E2 nodes as RAN nodes.

According to the present techniques, the average cell throughput can be predicted with the assumption that the UE of interest is handed over to the given cell. To do this, features from both the cell and UE side can be used.

The cell's current throughput, and other load metrics like available physical resource blocks (PRBs), PRB utilization, and number of connected UEs can be used from the cell side. From the UE side, current perceived channel conditions from the target cell and the UE's 5G quality-of-service (QOS) indicator (5QI) can be used.

The features can be used to output two numbers. A first number can be the predicted average cell throughput after the UE is handed over. A second number can be the UE's predicted quality-of-experience (QoE) after being handed over. In some examples, these can be two KPIs that are important to evaluate the handover before executing the handover.

The QoE can be flexible, based on the use-case. Described below are two examples for enhanced mobile broadband (eMBB) and ultra reliable and low-latency communications (URLLC) use cases, in which the QoE is defined as throughput and delay, respectively.

According to the present techniques, a ML model can be designed as a multi-target regressor architecture. In other examples, a model can be a tree-based model or a dep learning model.

A user that is currently connected to a cell (via user equipment) can be offloaded to another cell for different reasons as:
Load balancing between cells;
Energy saving (switching off a cell);
Interference avoidance;
An anomaly detection xApp spotted anomaly in the user KPIs while connected to the serving cell;
A RF handover (where a metric for the UE in a neighbor cell becomes better than the metric in the current cell; these can be referred to as A3 events in a 5G NR event reporting context).

Unguided handovers can result in further degradation in the QoE for a user, and/or unacceptable degradations in the QoE of existing users on the destination cell. This problem can be addressed according to the present techniques using a multi-target machine learning regressor that can be trained to predict what will be the QoE the user will have in the new cell should the handover occur. Another prediction can be the effect on the QoE of the existing users on the new cell.

By having a multi-target prediction on all selected neighbor cells, this can result in an intelligent handover decision, by selecting a best (or suitable) match between the user and the neighbor cells. In some examples, selected neighbor cells for a user can be cells having an acceptable RF coverage, to avoid a potential ping-pong effect.

There are prior approaches to mitigating potential negative impacts of handovers. One approach is load balancing with thresholds, where a load balancer considers a current load and predefined thresholds to trigger handovers.

Another approach is static network slicing. This can allow a creation of dedicated slices with specific quality characteristics. Another approach is quality-aware handovers with predefined thresholds.

Another approach is forecasting an average cell throughput. Here, a handover can be performed based on a highest forecasted average cell throughput. While this approach can be dynamic, it can lack information about RF conditions of a UE and the UE's 5QI. The forecasting can be irrelevant to a process of adding an additional UE to a cell. Accordingly, utilizing these factors can result in inaccurate predictions for an average cell throughput. Moreover, it can be that this approach does not predict the UE's QoE.

Together, prior approaches lack a focus on a nominated UE's performance and the experiences of existing users in destination cells.

Additionally, regarding prior approaches to address potential drawbacks associated with handovers, load balancing with thresholds can be used. Load balancing techniques can take into account both current load conditions and predefined thresholds, effectively averting unnecessary handovers that could adversely affect QoE. Additionally, prior approaches with static network slicing can introduce a strategic approach to QoE differentiation in fifth generation (5G) networks, allowing for the creation of dedicated slices tailored to specific quality characteristics. This allocation of resources can ensure a maintenance of QoE during handovers across various services and applications. However, these prior approaches do not consider the nominated UE performance, and the experiences of users already in the destination cells.

### Example Architectures, Etc.

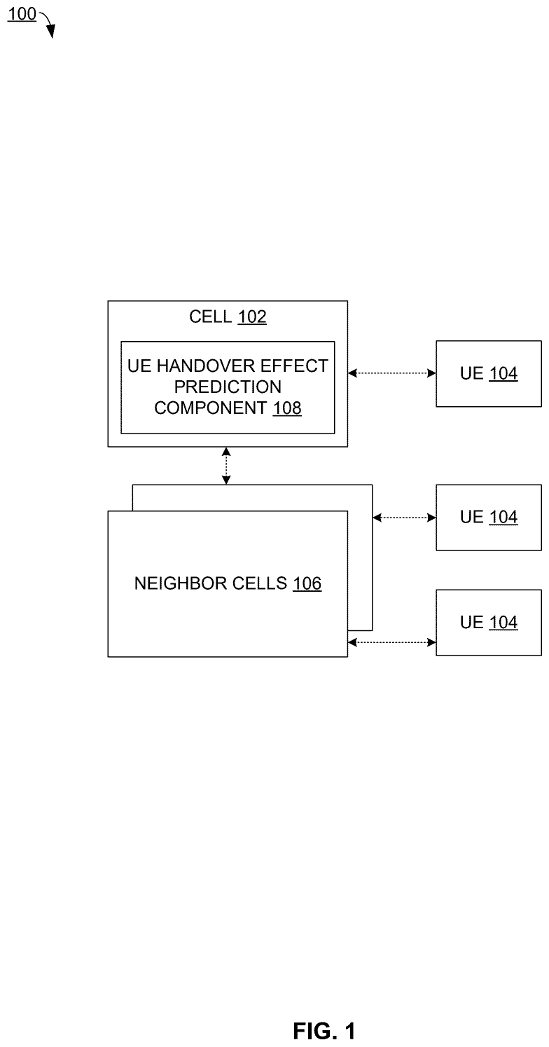

FIG. 1 illustrates an example system architecture 100 that can facilitate UE handover effect prediction, in accordance with an embodiment of this disclosure.

System architecture 100 comprises cell 102, UE 104, UEs 104A, UEs 104B, and neighbor cells 106. In turn, cell 102 comprises UE handover effect prediction component 108.

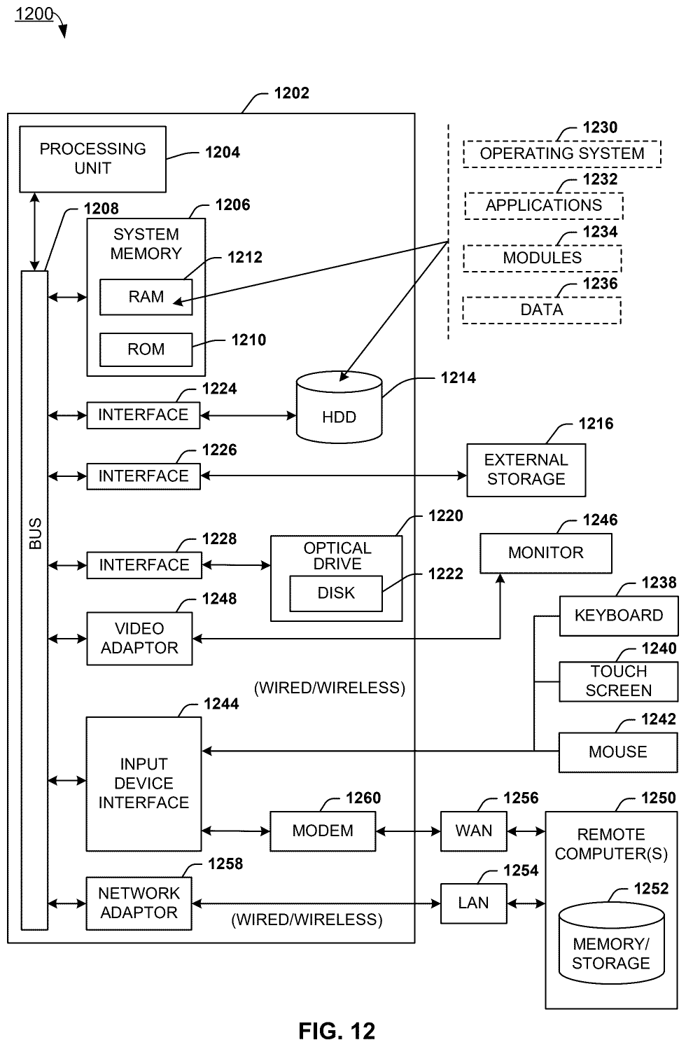

Each of cell 102, UE 104, UEs 104A, UEs 104B, and/or neighbor cells 106 can be implemented with part(s) of computing environment 1200 of FIG. 12.

Cell 102 and neighbor cells 106 can comprise a broadband cellular network, where a UE generally communicates with one cell. It can be that handovers are performed between two cells of cell 102 and neighbor cells 106, where the cell that serves a particular UE is switched (that is, the UE is “handed over” to another cell).

Cell 102 (which can sometimes be referred to as a gNodeB (gNB), or a base station) can communicate with UE 104. UE handover effect prediction component 108 can determine whether to handover UE 104 to a cell of neighbor cells 106. In making this determination, UE handover effect prediction component 108 can evaluate factors such as a predicted QoE of UE 104 if it joined a particular neighbor cell, and a predicted average QoE of UEs already communicating with that neighbor cell. UE handover effect prediction component 108 can perform this for each neighbor cell.

For example, UEs 104A can communicate with one cell of neighbor cells 106, and UEs 104B can communicate with another cell of neighbor cells 106. UE handover effect prediction component 108 can determine an average QoE of UEs 104A if UE 104 is handed over to their cell, and can determine an average QoE of UEs 1044 if UE 104 is handed over to their cell. In some examples, UE handover effect prediction component 108 can select the cell of neighbor cells 106 with a highest determined score as the cell with which to perform a handover of UE 104.

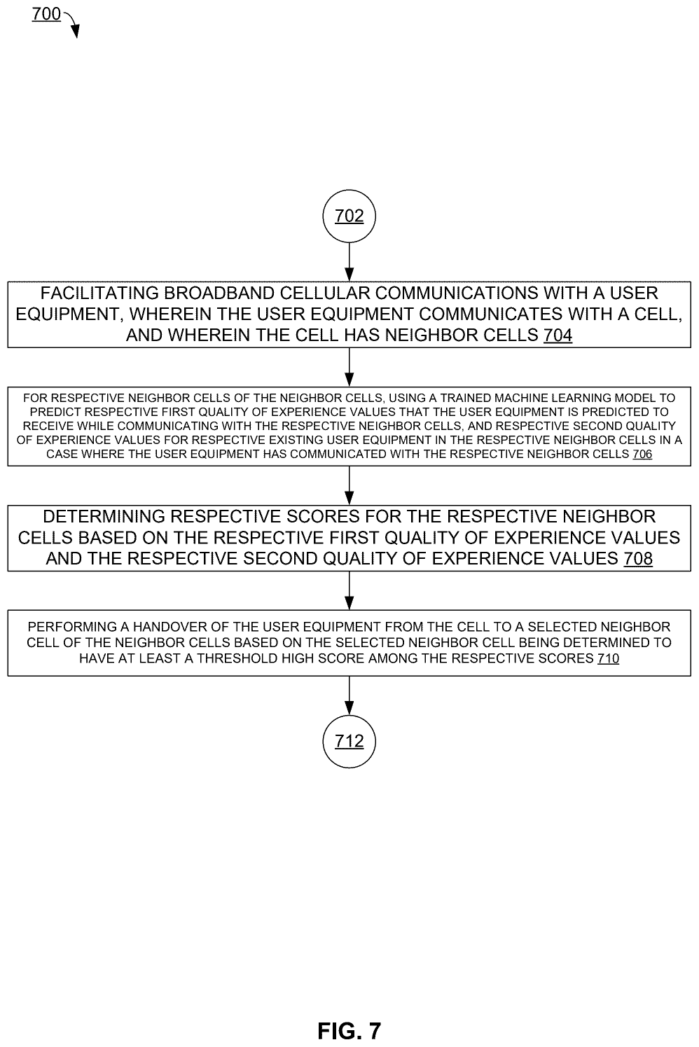

In some examples, UE handover effect prediction component 108 can implement part(s) of the process flows of FIGS. 7-11 to facilitate UE handover effect prediction.

It can be appreciated that system architecture 100 is one example system architecture for proactive prevention of data unavailability and data loss, and that there can be other system architectures that facilitate UE handover effect prediction.

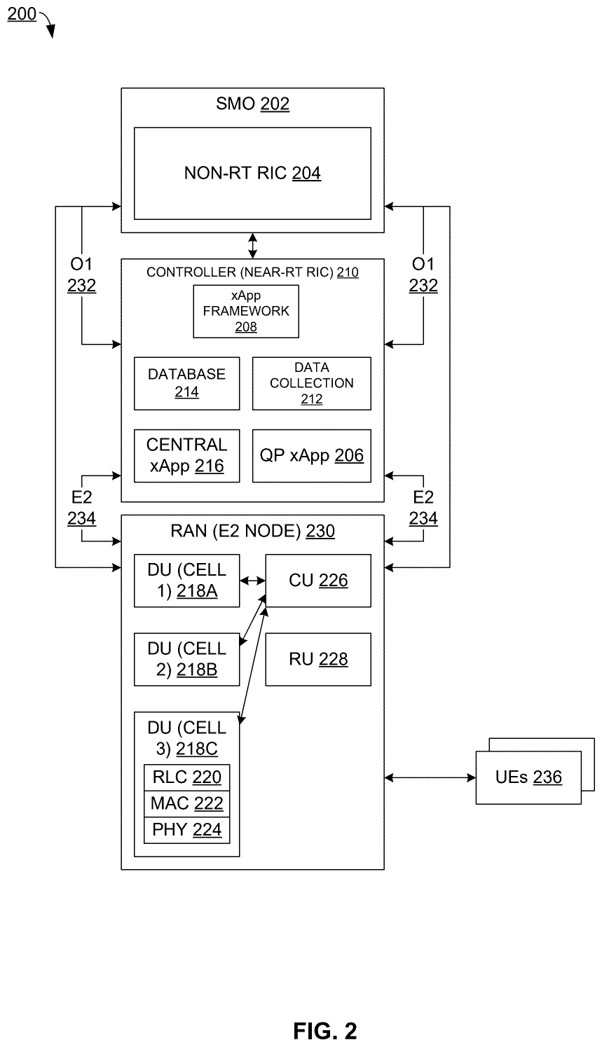

FIG. 2 illustrates another example system architecture 200 that can facilitate UE handover effect prediction, in accordance with an embodiment of this disclosure. In some examples, part(s) of system architecture 200 can be implemented by part(s) of system architecture 100 of FIG. 1 to facilitate UE handover effect prediction.

System architecture 200 comprises SMO 202, non-RT RIC 204, QoE prediction (QP) xApp 206, xApp framework 208, controller (near-RT RIC) 210, data collection 212, database 214, central xApp 216, DU (cell 1) 218A, DU (cell 2) 218B, DU (cell 2) 218C, radio link control (RLC) 220, medium access control (MAC) 222, physical (PHY) 224, CU 226, RU 228, RAN (E2 node) 230, O1 232, E2 234, and UEs 236.

A system architecture in which the present techniques are implemented can be as follows. A SMO can act as a management and orchestration layer that controls configuration and automation aspects of RIC and RAN elements. The SMO can onboard xApps and rApps onto the RIC components.

A near-RT RIC can comprise a QP xApp that is configured to execute a multi-target regressor ML model responsible for predicting the QoE if a UE joins a new cell; and a central xApp that is configured to trigger a request for handover and request cell scores for candidate cells from the QP xApp. The central xApp can be configured to send a control message to an E2 node to perform the handover. The near-RT RIC can also comprise an xApp framework that can expose an application programming interface for xApps to subscribe on new registered E2 nodes and configuration updates; and a database that can be configured to store KPIs collected from E2 nodes, as well as subscription details (e.g., requested KPIs, and/or accepted/failed requests).

A model according to the present techniques can use KPIs related to the UE that will perform the handover, in addition to KPIs related to the new candidate cells. This can help the model make more accurate predictions by accounting for features mimicking realistic conditions.

A problem to be solved can be formulated as joint objective function that aims to maximize a user QoE on the new cell while minimizing a QoE degradation on existing users.

In contrast to prior approaches, the present techniques can provide dynamic intelligent predictions for the QoE of the users involved in the potential handover. UE and cell KPIs can be used by a ML model to achieve realistic predictions.

Accordingly, a multi-target regressor according to the present techniques can be used to predict the QoE of the new UE, and the QoE of existing UEs.

A cell score can then be determined using the predicted outputs for each neighbor cell in a list.

The list of neighbor cells can be those where the UE reports acceptable RF coverage from them. In some examples, a cell with a highest cell score can be selected for the handover.

Training data collection can involve collecting data samples at a time of handovers. Input and output KPIs can be averaged in a time window before and after handovers, respectively.

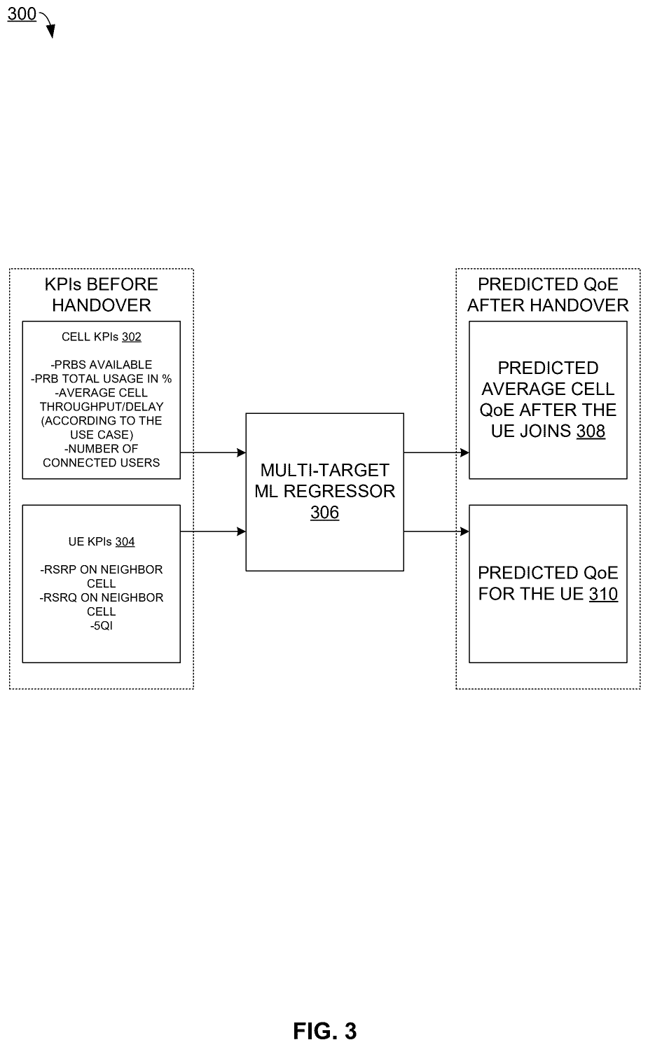

FIG. 3 illustrates another example system architecture 300 that can facilitate UE handover effect prediction, in accordance with an embodiment of this disclosure. In some examples, part(s) of system architecture 300 can be implemented by part(s) of system architecture 100 of FIG. 1 to facilitate UE handover effect prediction.

System architecture 300 comprises cell KPIs 302, UE KPIs 304, multi-target ML regressor 306, predicted average cell QoE after the UE joins 308, and predicted QoE for the UE 310.

A cell score can be determined as:

$$Cell score = α \frac{Predicted UE QoE}{UE QoE on previous cell} + ( 1 - α ) \frac{Predicted average cell QoE}{average cell QoE before handover}$$

where α is a weighting term between 0 and 1. It can be configured by the operator, where a value of zero gives full weight for the cell average term, and a value of 1 gives full weight for the UE term.

The two terms of the equations can be normalized by the previous conditions before handover. This can be performed to let the equation terms measure the percentage of improvement/degradation rather than absolute QoE KPIs.

A weighting can be implemented to prevent ping pong transmissions. That is, after handover, a waiting period can occur to see what the QoE is, so that the UE is not moved too frequently. In some examples, operators can generally give a cell portion of a score a higher priority than the UE's portion of the score.

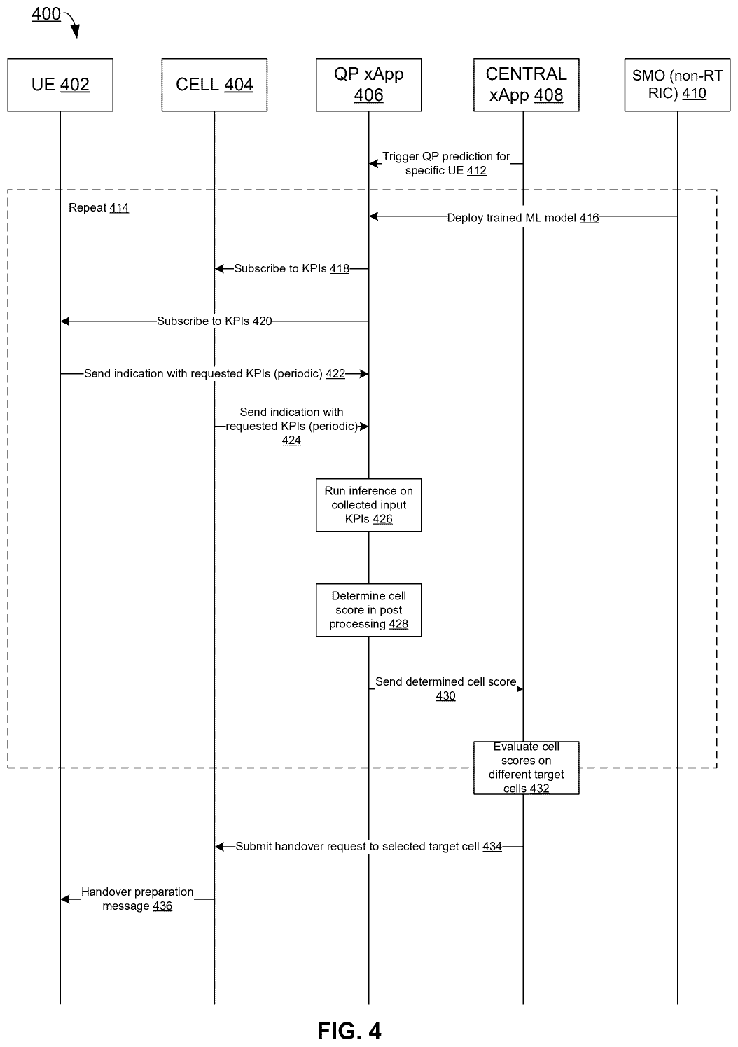

FIG. 4 illustrates an example signal flow 400 that can facilitate UE handover effect prediction, in accordance with an embodiment of this disclosure. In some examples, part(s) of signal flow 400 can be implemented by part(s) of system architecture 100 of FIG. 1 to facilitate UE handover effect prediction.

Components of FIG. 4 that transmit signals are UE 402, cell 404, QP xApp 406, central xApp 408, and SMO (non-RT RIC) 410). Central xApp 408 can comprise an xApp that utilizes QP xApp 408's functionality for a purpose of implementing handovers. Central xApp 408 can trigger a QP prediction based on logic determining a given UE to be handed over to a given target cell.

Signals sent between these components are:
Trigger QP prediction for specific UE 412
Repeat 414
Deploy trained ML model 416
Subscribe to KPIs 418
Subscribe to KPIs 420
Send indication with requested KPIs (periodic) 422
Send indication with requested KPIs (periodic) 424
Run inference on collected input KPIs 426
Determine cell score in post processing 428
Send determined cell score 430
Evaluate cell scores on different target cells 432
Submit handover request to selected target cell 434
Handover preparation message 436

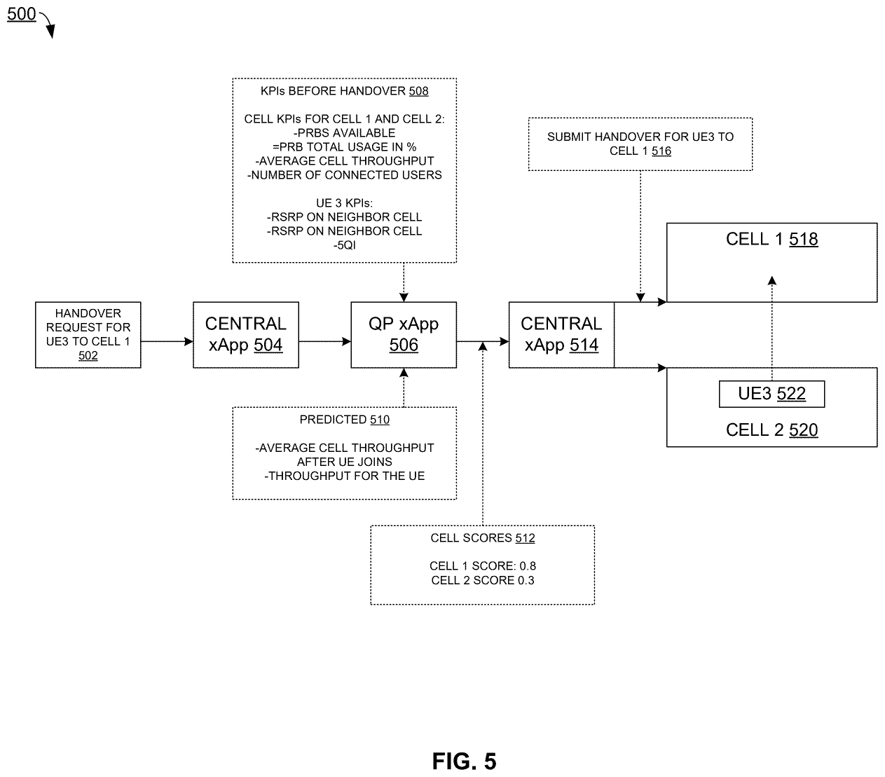

FIG. 5 illustrates another example system architecture 500 that can facilitate UE handover effect prediction, in accordance with an embodiment of this disclosure. In some examples, part(s) of system architecture 500 can be implemented by part(s) of system architecture 100 of FIG. 1 to facilitate UE handover effect prediction.

System architecture 500 can illustrate a use case according to the present techniques that relates to eMBB and throughput prediction.

System architecture 500 comprises handover request for UE3 to cell 1 502, central xApp 504, QP xApp 506, KPIs before handover 508, predicted 510, cell scores 512, central xApp 514, submit handover for UE3 to cell 1 516, cell 1 518, cell 2 520, and UE3 522.

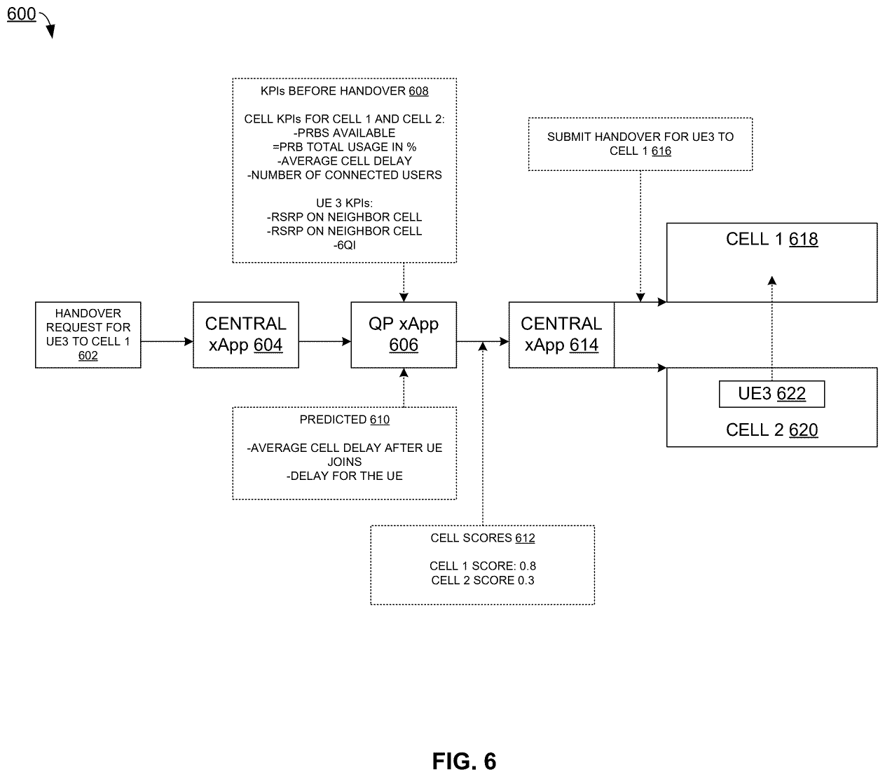

FIG. 6 illustrates another example system architecture that can facilitate UE handover effect prediction, in accordance with an embodiment of this disclosure. In some examples, part(s) of system architecture 600 can be implemented by part(s) of system architecture 100 of FIG. 1 to facilitate UE handover effect prediction.

System architecture 600 can illustrate a use case according to the present techniques that relates to URLLC and delay prediction.

System architecture 600 comprises handover request for UE3 to cell 1 602, central xApp 604, QP xApp 606, KPIs before handover 608, predicted 610, cell scores 612, central xApp 614, submit handover for UE3 to cell 1 616, cell 1 618, cell 2 620, and UE3 622.

A difference between the example of FIG. 5 and the example of FIG. 6 can generally be that FIG. 5 relates to a QoE metric of throughput, while FIG. 6 relates to a QoE metric of delay.

### Example Process Flows

FIG. 7 illustrates an example process flow 700 for UE handover effect prediction, in accordance with an embodiment of this disclosure. In some examples, one or more embodiments of process flow 700 can be implemented by system architecture 100 of FIG. 1, or computing environment 1200 of FIG. 12.

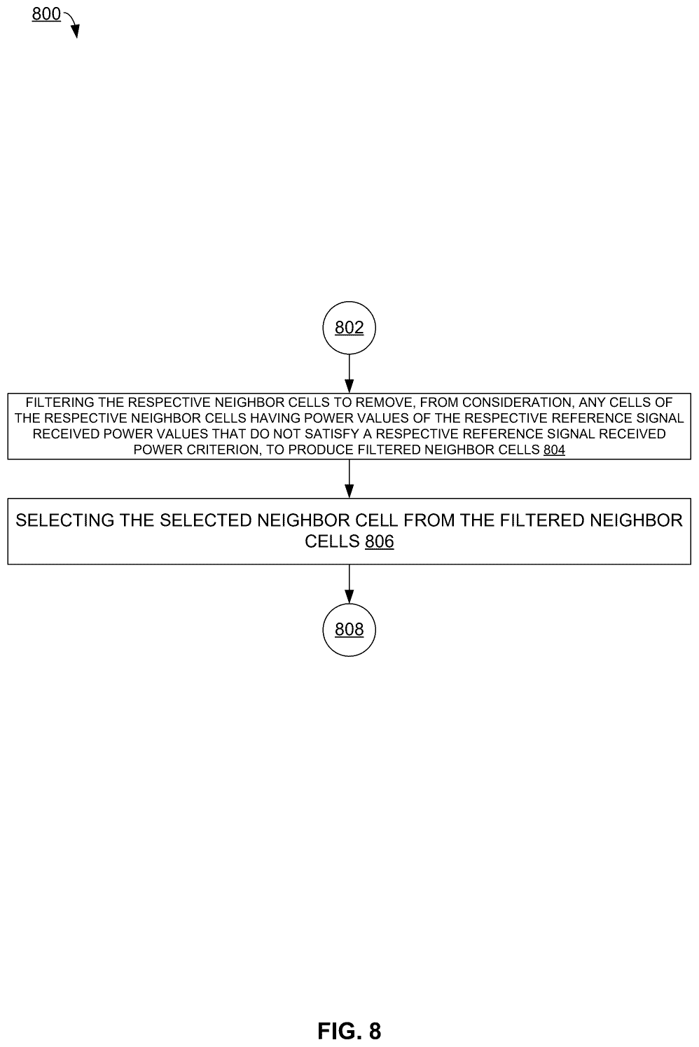

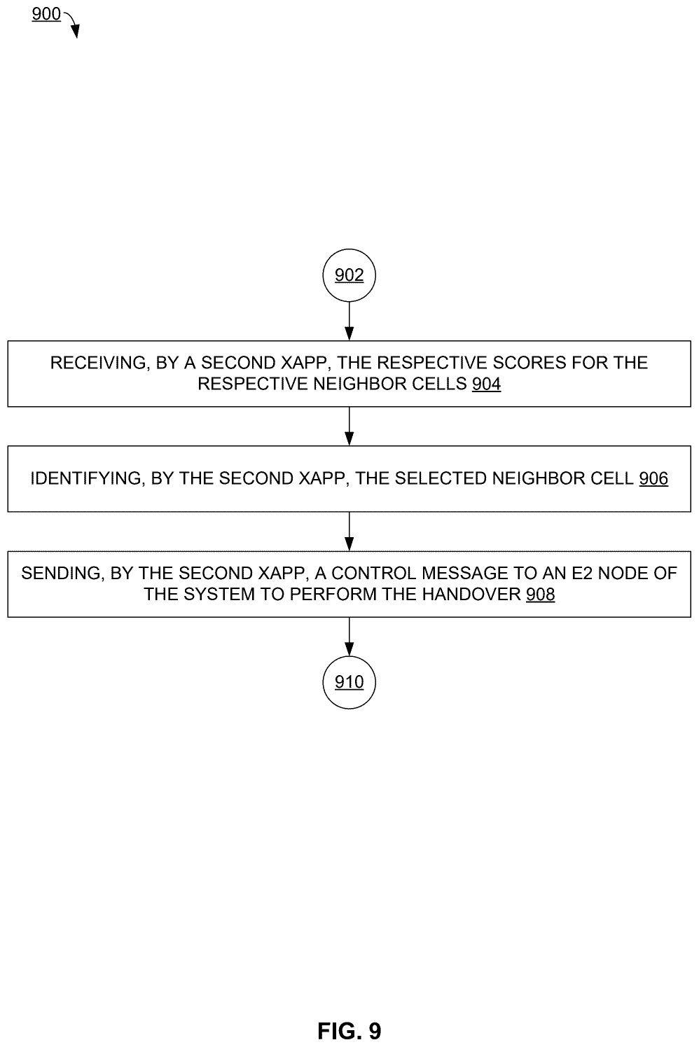

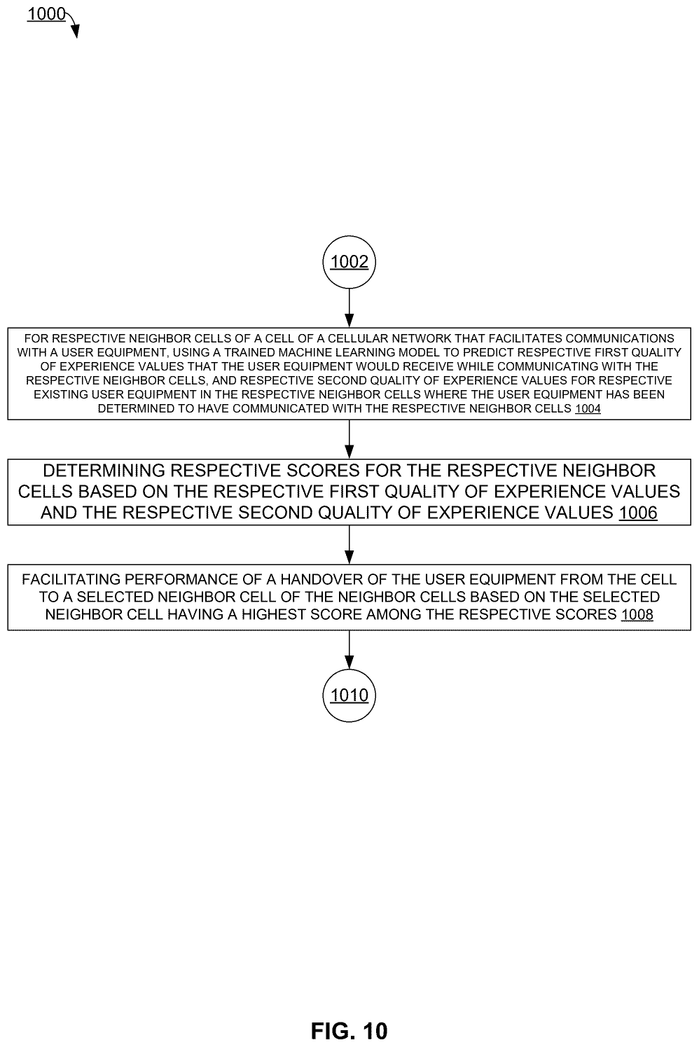

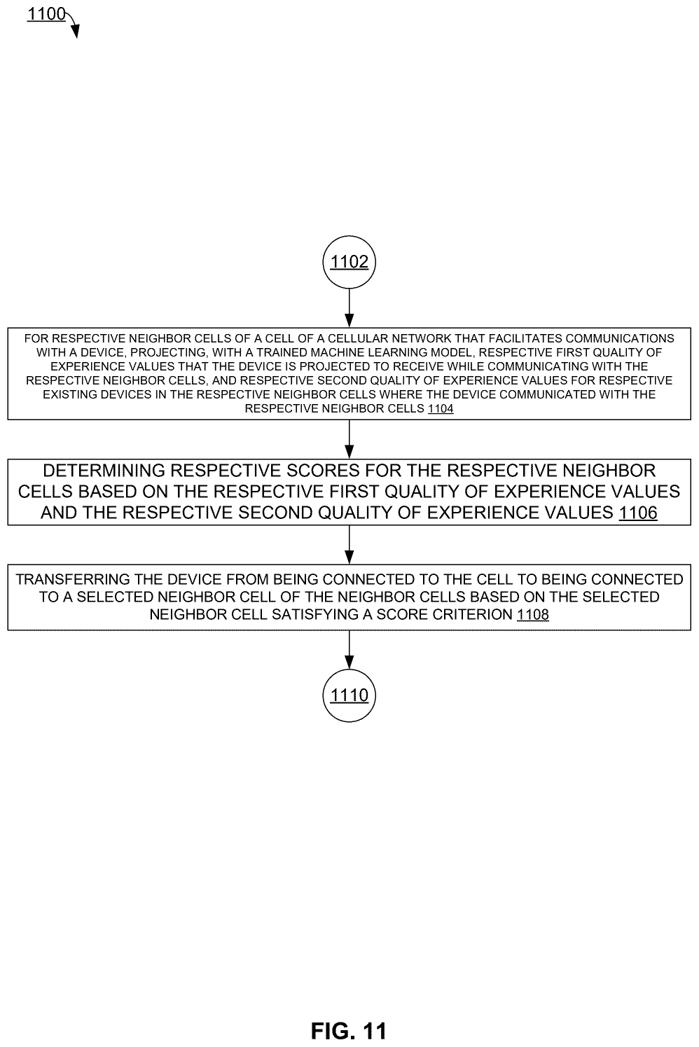

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 800 of FIG. 8, process flow 900 of FIG. 9, process flow 1000 of FIG. 10, and/or process flow 1100 of FIG. 11.

Process flow 700 begins with 702, and moves to operation 704.

Operation 704 depicts facilitating broadband cellular communications with a user equipment, wherein the user equipment communicates with a cell, and wherein the cell has neighbor cells. That is, there can be cellular broadband communications between a gNB and a UE.

After operation 704, process flow 700 moves to operation 706.

Operation 706 depicts, for respective neighbor cells of the neighbor cells, using a trained machine learning model to predict respective first quality of experience values that the user equipment is predicted to receive while communicating with the respective neighbor cells, and respective second quality of experience values for respective existing user equipment in the respective neighbor cells in a case where the user equipment has communicated with the respective neighbor cells. That is, for each neighbor cell, an ML model can be used to predict both the UE's QoE in that cell if handover to that cell is performed, and an average QoE of UEs already communicating with that cell if handover of the UE to that cell is performed.

In some examples, the trained machine learning model operates within an xApp of the system that operates in a near-real time radio access network intelligent controller of the system. That is, the ML model can be deployed in an xApp that runs in an nRT RIC.

In some examples, inputs to the trained machine learning model are accessible via at least one E2 service model. That is, in an ORAN architecture, the ML model can receive KPI information supplied through an E2 service model (E2SM).

In some examples, the respective second quality of experience values comprise respective average quality of experience values among the respective existing user equipment in the respective neighbor cells in the case where the user equipment has communicated with the respective neighbor cells. That is, the ML model can predict the UE QoE should it join a neighbor cell, together with predicting the average target cell QoE if the UE is offloaded to the neighbor cell.

After operation 706, process flow 700 moves to operation 708.

Operation 708 depicts determining respective scores for the respective neighbor cells based on the respective first quality of experience values and the respective second quality of experience values. That is, a numerical score can be determined for each neighbor cell based on those determinations of operation 706.

In some examples, determining the respective scores for the respective neighbor cells based on the respective first quality of experience values and the respective second quality of experience values is performed based on a first weighting of the respective first quality of experience values and a second weighting of the respective second quality of experience values. In some examples, the first weighting and the second weighting are configurable by an operator of the system. That is, a weighting between how much each of these determinations goes into the score can be made, and this can be configured by an operator of the cellular network.

After operation 708, process flow 700 moves to operation 710.

Operation 710 depicts performing a handover of the user equipment from the cell to a selected neighbor cell of the neighbor cells based on the selected neighbor cell being determined to have at least a threshold high score among the respective scores. That is, a handover of the UE to a neighbor cell can be performed to a neighbor cell that has a sufficiently high score (for example, a highest score among the neighbor cells). In some examples, it can be determined not to perform a handover, such as where a score for the UE's current cell is the highest.

After operation 710, process flow 700 moves to 712, where process flow 700 ends.

FIG. 8 illustrates an example process flow 800 for UE handover effect prediction, in accordance with an embodiment of this disclosure. In some examples, one or more embodiments of process flow 800 can be implemented by system architecture 100 of FIG. 1, or computing environment 1200 of FIG. 12.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 700 of FIG. 7, process flow 900 of FIG. 9, process flow 1000 of FIG. 10, and/or process flow 1100 of FIG. 11.

Process flow 800 begins with 802, and moves to operation 804.

In some examples where process flow 800 is implemented in conjunction with process flow 700 of FIG. 7, the respective neighbor cells are associated with respective reference signal received power values.

Operation 804 depicts filtering the respective neighbor cells to remove, from consideration, any cells of the respective neighbor cells having power values of the respective reference signal received power values that do not satisfy a respective reference signal received power criterion, to produce filtered neighbor cells. That is, in some examples, candidate neighbor cells for a UE can be filtered (or selected) based on exceeding certain RF measurement thresholds. This can be to determine that a handover will not degrade RF measurements for the UE to unacceptable levels.

After operation 804, process flow 800 moves to operation 806.

Operation 806 depicts selecting the selected neighbor cell from the filtered neighbor cells. In some examples where process flow 800 is implemented in conjunction with process flow 700 of FIG. 7, the filtered neighbor cells comprise the selected neighbor cell, and the selected neighbor cell has at least the threshold high score among scores of the respective scores of the filtered neighbor cells. That is, a neighbor cell for a handover can be selected from the filtered neighbor cells of operation 804 rather than from all neighbor cells.

After operation 806, process flow 800 moves to 808, where process flow 800 ends.

FIG. 9 illustrates an example process flow 900 for UE handover effect prediction, in accordance with an embodiment of this disclosure. In some examples, one or more embodiments of process flow 900 can be implemented by system architecture 100 of FIG. 1, or computing environment 1200 of FIG. 12.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 700 of FIG. 7, process flow 800 of FIG. 8, process flow 1000 of FIG. 10, and/or process flow 1100 of FIG. 11.

Process flow 900 begins with 902, and moves to operation 904.

In some examples where process flow 900 is implemented in conjunction with process flow 700 of FIG. 7, the xApp is a first xApp.

Operation 904 depicts receiving, by a second xApp, the respective scores for the respective neighbor cells. That is, the first xApp can determine the scores, and the second xApp can handle triggering handover requests.

After operation 904, process flow 900 moves to operation 906.

Operation 906 depicts identifying, by the second xApp, the selected neighbor cell. That is, the second xApp can determine which neighbor cell to use for a handover based on the scores received from the first xApp.

After operation 906, process flow 900 moves to operation 908.

Operation 908 depicts sending, by the second xApp, a control message to an E2 node of the system to perform the handover. That is, the second xApp can trigger a handover by sending a control message to an E2 node to perform the handover.

After operation 908, process flow 900 moves to 910, where process flow 900 ends.

FIG. 10 illustrates an example process flow 1000 for UE handover effect prediction, in accordance with an embodiment of this disclosure. In some examples, one or more embodiments of process flow 1000 can be implemented by system architecture 100 of FIG. 1, or computing environment 1200 of FIG. 12.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 700 of FIG. 7, process flow 800 of FIG. 8, process flow 900 of FIG. 9, and/or process flow 1100 of FIG. 11.

Process flow 1000 begins with 1002, and moves to operation 1004.

Operation 1004 depicts, for respective neighbor cells of a cell of a cellular network that facilitates communications with a user equipment, using a trained machine learning model to predict respective first quality of experience values that the user equipment would receive while communicating with the respective neighbor cells, and respective second quality of experience values for respective existing user equipment in the respective neighbor cells where the user equipment has been determined to have communicated with the respective neighbor cells. In some examples, operation 1004 can be implemented in a similar manner as operations 704-706 of FIG. 7.

In some examples, the trained machine learning model comprises a multi-target regressor.

In some examples, operation 1004 comprises training a machine learning model to produce the trained machine learning model based on data samples collected at respective times of respective handovers in the cellular network. In some examples, the data samples comprise key performance indicators. In some examples, the data samples are averaged across respective time windows that comprise the respective times. That is, training data for a machine learning model can comprise data samples that are collected at a time of handovers. Input/output KPIs can be averaged in a window before/after the handovers.

In some examples, an input to the trained machine learning model comprises respective numbers of physical resources block available in the respective neighbor cells, respective physical resource block usage rates in the respective neighbor cells, respective average cell throughputs in the respective neighbor cells, respective average cell delays in the respective neighbor cells, or respective numbers of connected user equipment in the respective neighbor cells. That is, cell KPIs can comprise PRBs available, PRB total usage (e.g., expressed in a percentage), average cell throughput/delay (according to a particular use case), and/or a number of connected users.

In some examples, an input to the trained machine learning model comprises respective reference signal received power values for the user equipment on the respective neighbor cells, respective reference signal received quality values for the user equipment on the respective neighbor cells, or respective fifth generation quality of service indicator values for the user equipment on the respective neighbor cells. That is, UE KPIs can comprise RSRP on a neighbor cell, RSRP on a neighbor cell, and/or 5QI.

After operation 1004, process flow 1000 moves to operation 1006.

Operation 1006 depicts determining respective scores for the respective neighbor cells based on the respective first quality of experience values and the respective second quality of experience values. In some examples, operation 1006 can be implemented in a similar manner as operation 708 of FIG. 7.

After operation 1006, process flow 1000 moves to operation 1008.

Operation 1008 depicts facilitating performance of a handover of the user equipment from the cell to a selected neighbor cell of the neighbor cells based on the selected neighbor cell having a highest score among the respective scores. In some examples, operation 1008 can be implemented in a similar manner as operations 704-706 of FIG. 7.

After operation 1008, process flow 1000 moves to 1010, where process flow 1000 ends.

FIG. 11 illustrates an example process flow 1100 for UE handover effect prediction, in accordance with an embodiment of this disclosure. In some examples, one or more embodiments of process flow 1100 can be implemented by system architecture 100 of FIG. 1, or computing environment 1200 of FIG. 12.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 700 of FIG. 7, process flow 800 of FIG. 8, process flow 900 of FIG. 9, and/or process flow 1000 of FIG. 10.

Process flow 1100 begins with 1102, and moves to operation 1104.

Operation 1104 depicts, for respective neighbor cells of a cell of a cellular network that facilitates communications with a device, projecting, with a trained machine learning model, respective first quality of experience values that the device is projected to receive while communicating with the respective neighbor cells, and respective second quality of experience values for respective existing devices in the respective neighbor cells where the device communicated with the respective neighbor cells. In some examples, operation 1104 can be implemented in a similar manner as operations 704-706 of FIG. 7.

In some examples, the cellular network comprises network slices, a slice of the network slices that corresponds to the communications with the device comprise enhanced mobile broadband communications, the respective first quality of experience values comprise respective throughputs for the device, and the respective second quality of experience values comprise respective average cell throughputs of the respective neighbor cells. That is, a prediction of the trained ML model can be average cell throughput after a UE joins the cell, and/or throughput for the UE after the UE joins the cell.

In some examples, the cellular network comprises network slices, a slice of the network slices that corresponds to the communications with the device comprise ultra reliable low latency communications, the respective first quality of experience values comprise respective delays for the device, and the respective second quality of experience values comprise respective average cell delays of the respective neighbor cells. That is, a prediction of the trained ML model can be average cell delay after a UE joins the cell, and/or delay for the UE after the UE joins the cell.

After operation 1104, process flow 1100 moves to operation 1106.

Operation 1106 depicts determining respective scores for the respective neighbor cells based on the respective first quality of experience values and the respective second quality of experience values. In some examples, operation 1006 can be implemented in a similar manner as operation 708 of FIG. 7.

In some examples, determining the respective scores is based on respective ratios of the respective first quality of experience values to a quality of experience value experienced by the device on the cell. In some examples, determining the respective scores is based on respective ratios of the respective second quality of experience values to respective third quality of experience values for the respective existing devices in the respective neighbor cells where the device does not communicate with the respective neighbor cells.

That is, a cell score can be determined as:

$$Cell score = α \frac{Predicted UE QoE}{UE QoE on previous cell} + ( 1 - α ) \frac{Predicted average cell QoE}{average cell QoE before handover}$$

where α is a weighting term between 0 and 1. It can be configured by the operator, where a value of zero gives full weight for the cell average term, and a value of 1 gives full weight for the UE term.

After operation 1106, process flow 1100 moves to operation 1108.

Operation 1108 depicts transferring the device from being connected to the cell to being connected to a selected neighbor cell of the neighbor cells based on the selected neighbor cell satisfying a score criterion. In some examples, operation 1108 can be implemented in a similar manner as operation 710 of FIG. 7.

After operation 1108, process flow 1100 moves to 1110, where process flow 1100 ends.

### Example Operating Environment

In order to provide additional context for various embodiments described herein, FIG. 12 and the following discussion are intended to provide a brief, general description of a suitable computing environment 1200 in which the various embodiments of the embodiment described herein can be implemented.

For example, parts of computing environment 1200 can be used to implement one or more embodiments of cell 102, UE 104, UEs 104A, UEs 104B, and/or neighbor cells 106 of FIG. 1.

In some examples, computing environment 1200 can implement one or more embodiments of the process flows of FIGS. 7-11 to facilitate UE handover effect prediction.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a nonvolatile storage such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples, and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1216 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
facilitating broadband cellular communications with a user equipment, wherein the user equipment communicates with a cell, and wherein the cell has neighbor cells;
for respective neighbor cells of the neighbor cells, using a trained machine learning model to predict respective first quality of experience values that the user equipment is predicted to receive while communicating with the respective neighbor cells, and respective second quality of experience values for respective existing user equipment in the respective neighbor cells in a case where the user equipment has communicated with the respective neighbor cells;
determining respective scores for the respective neighbor cells based on the respective first quality of experience values and the respective second quality of experience values; and
performing a handover of the user equipment from the cell to a selected neighbor cell of the neighbor cells based on the selected neighbor cell being determined to have at least a threshold high score among the respective scores.

2. The system of claim 1, wherein the respective neighbor cells are associated with respective reference signal received power values, and wherein the operations further comprise:
filtering the respective neighbor cells to remove, from consideration, any cells of the respective neighbor cells having power values of the respective reference signal received power values that do not satisfy a respective reference signal received power criterion, to produce filtered neighbor cells,
wherein the filtered neighbor cells comprise the selected neighbor cell, and wherein the selected neighbor cell has at least the threshold high score among scores of the respective scores of the filtered neighbor cells.

3. The system of claim 1, wherein determining the respective scores for the respective neighbor cells based on the respective first quality of experience values and the respective second quality of experience values is performed based on a first weighting of the respective first quality of experience values and a second weighting of the respective second quality of experience values.

4. The system of claim 3, wherein the first weighting and the second weighting are configurable by an operator of the system.

5. The system of claim 1, wherein the trained machine learning model operates within an xApp of the system that operates in a near-real time radio access network intelligent controller of the system.

6. The system of claim 5, wherein inputs to the trained machine learning model are accessible via at least one E2 service model.

7. The system of claim 5, wherein the xApp is a first xApp, and wherein the operations further comprise:
receiving, by a second xApp of the system, the respective scores for the respective neighbor cells;
identifying, by the second xApp, the selected neighbor cell; and
sending, by the second xApp, a control message to an E2 node of the system to perform the handover.

8. The system of claim 1, wherein the respective second quality of experience values comprise respective average quality of experience values among the respective existing user equipment in the respective neighbor cells in the case where the user equipment has communicated with the respective neighbor cells.

9. A method, comprising:
for respective neighbor cells of a cell of a cellular network that facilitates communications with a user equipment, using, by a system comprising at least one processor, a trained machine learning model to predict respective first quality of experience values that the user equipment would receive while communicating with the respective neighbor cells, and respective second quality of experience values for respective existing user equipment in the respective neighbor cells where the user equipment has been determined to have communicated with the respective neighbor cells;
determining, by the system, respective scores for the respective neighbor cells based on the respective first quality of experience values and the respective second quality of experience values; and
facilitating, by the system, performance of a handover of the user equipment from the cell to a selected neighbor cell of the neighbor cells based on the selected neighbor cell having a highest score among the respective scores.

10. The method of claim 9, wherein the trained machine learning model comprises a multi-target regressor.

11. The method of claim 9, further comprising:
training, by the system, a machine learning model to produce the trained machine learning model based on data samples collected at respective times of respective handovers in the cellular network.

12. The method of claim 11, wherein the data samples comprise key performance indicators.

13. The method of claim 11, wherein the data samples are averaged across respective time windows that comprise the respective times.

14. The method of claim 9, wherein an input to the trained machine learning model comprises respective numbers of physical resources block available in the respective neighbor cells, respective physical resource block usage rates in the respective neighbor cells, respective average cell throughputs in the respective neighbor cells, respective average cell delays in the respective neighbor cells, or respective numbers of connected user equipment in the respective neighbor cells.

15. The method of claim 9, wherein an input to the trained machine learning model comprises respective reference signal received power values for the user equipment on the respective neighbor cells, respective reference signal received quality values for the user equipment on the respective neighbor cells, or respective fifth generation quality of service indicator values for the user equipment on the respective neighbor cells.

16. A non-transitory computer-readable medium comprising instructions that, in response to execution, cause a system comprising at least one processor to perform operations, comprising:
for respective neighbor cells of a cell of a cellular network that facilitates communications with a device, projecting, with a trained machine learning model, respective first quality of experience values that the device is projected to receive while communicating with the respective neighbor cells, and respective second quality of experience values for respective existing devices in the respective neighbor cells where the device communicated with the respective neighbor cells;
determining respective scores for the respective neighbor cells based on the respective first quality of experience values and the respective second quality of experience values; and
transferring the device from being connected to the cell to being connected to a selected neighbor cell of the neighbor cells based on the selected neighbor cell satisfying a score criterion.

17. The non-transitory computer-readable medium of claim 16, wherein determining the respective scores is based on respective ratios of the respective first quality of experience values to a quality of experience value experienced by the device on the cell.

18. The non-transitory computer-readable medium of claim 16, wherein determining the respective scores is based on respective ratios of the respective second quality of experience values to respective third quality of experience values for the respective existing devices in the respective neighbor cells where the device does not communicate with the respective neighbor cells.

19. The non-transitory computer-readable medium of claim 16, wherein the cellular network comprises network slices, wherein a slice of the network slices that corresponds to the communications with the device comprise enhanced mobile broadband communications, wherein the respective first quality of experience values comprise respective throughputs for the device, and wherein the respective second quality of experience values comprise respective average cell throughputs of the respective neighbor cells.

20. The non-transitory computer-readable medium of claim 16, wherein the cellular network comprises network slices, wherein a slice of the network slices that corresponds to the communications with the device comprise ultra reliable low latency communications, wherein the respective first quality of experience values comprise respective delays for the device, and wherein the respective second quality of experience values comprise respective average cell delays of the respective neighbor cells.
